(19) United States
(12) Patent Application Publication
(10) Pub. No.: US 2024/0214860 A1
(43) Pub. Date: Jun. 27, 2024

(54) SYSTEM AND METHOD FOR COMMUNICATIONS ASSURANCE ANALYSIS

(71) Applicant: MOTOROLA SOLUTIONS, INC., Chicago, IL (US)

(72) Inventors: MATTHEW E SIMMS, DAVIE, FL (US); CHIRAYU M PATEL, LAWRENCEVILLE, GA (US)

(21) Appl. No.: 18/145,030

(22) Filed: Dec. 22, 2022

(51) Int. Cl. H04W 28/02; H04B 17/391

(52) U.S. Cl. CPC H04W 28/0236; H04B 17/391; H04W 28/0289

(57) ABSTRACT

Techniques for communications assurance analysis are provided. A communications assurance analysis system retrieves performance points of a plurality of stages of a single radio call. A level of degradation for each stage of the plurality of stages of the single radio call is determined based on the performance points. A visualization of each stage of the single radio call is displayed. The visualization is in order of a communications path between an initiator of the single radio call and at least one recipient of the single radio call. The visualization for each stage of the plurality of stages is based on the level of degradation for the stage.

### BACKGROUND

Public safety responders may use radio communication systems in order to provide coordinated responses to public safety incidents. For example, first responders may utilize Land Mobile Radio (LMR) radio networks that operate under the Project 25 or Terrestrial Trunked Radio (TETRA) standards to provide communications between dispatchers and field personnel, as well as between the first responders themselves. The first responders may use mobile radio devices (e.g. car mounted radio, etc.), portable communications devices (e.g. walkie-talkies, etc.), or fixed stations (e.g. consoles, etc.).

Users of the radio communications system may be placed into groups, which can also be called talkgroups. When a user wishes to communicate, they may activate their communications device (e.g. press a Push-to-Talk (PTT) button). The user may then begin speaking (in some systems, waiting for a talk permit tone before speaking) and the audio is captured by the local device microphone. The audio may, in some cases be converted to a digital representation. The audio may be converted to a radio frequency transmission (RF) to be sent wirelessly to the radio communications system infrastructure.

The radio communications network infrastructure may then receive the RF communication. The received RF signal may be repeated and sent to one or more transmitting sites. The RF transmitting sites may send the RF signal containing the audio to devices affiliated with the talkgroup. Each of those devices may then convert the RF communication back to an audio signal and playout the audio via a speaker on the device.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a high level example of a communications network that may utilize the communications assurance analysis techniques described herein.

FIG. 2 depicts an example of a call stage tree for a single radio call 200.

FIG. 3 is an example of a user interface that may be utilized with the techniques described herein.

FIGS. 4A and 4B are an example of a flow chart that may implement the communications assurance analysis techniques described herein.

FIG. 5 is an example of a device that may implement the subscriber devices according to the techniques described herein.

FIG. 6 is an example of a device that may implement the call stage tree analysis engine according to the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Although the radio communications systems generally work very well, problems may arise when there are faults in one or more stages of the communication path. Such faults can be difficult to diagnose, as there may be one or more faults that affect recipients in the talkgroup in different ways. Some faults, for example those on the transmitting radio device, may prevent communications from being heard by anyone in the talkgroup. A fault on a receiving radio may only affect a single member of the talkgroup. Yet other faults (e.g. failure of a radio repeater, etc.) may affect a subset of members of the talkgroup, with the specific members determined by the nature of the fault. In some cases, separate faults that individually would not cause failure of communication can combine in such a way that the overall impact is greater than each individual fault.

For example, consider a public safety incident has wrapped up, and the incident commander sends a communication (e.g. a call) out to all members of the talkgroup indicating that the incident is over and all talkgroup members should return to their normally assigned duties. Six members of the talk group, Bob, Jerry, Alan, Faris, Kelly, and Nardo claim that they never received the call indicating the incident was over. All other talkgroup members were able to hear the call. For ease of description, assume there were no problems with the communication from the incident commander's radio to the base station, as if there was a problem with this portion of the call, then no one in the talkgroup would have received the call.

Bob's radio may have received the call, unmuted, and attempted to output the call over the radio speaker. However, the volume of Bob's radio may have been set so low that he did not hear the call. Jerry's radio may have been inadvertently left out of the talkgroup, thus that radio would not have even known that a call was directed to it. Alan's radio may have experienced a high bit error rate (BER) because Alan had installed an unapproved, after market antenna on his radio. As such, Alan's radio was not able to accurately receive the call from the incident commander.

Faris and Kelly may have had their radios connected to a RF site that was experiencing RF transmission problem, and as such were unable to receive the call from the RF site. Nardo's radio may have simply been in the off state, meaning it would not have been possible for Nardo to have received the call from the incident commander.

As should be clear, diagnosing these problem may become complicated, as each radio may have experienced problems in receiving the call that were specific to the particular radio. For example, the failure of the RF transmission site was the cause of the problem for Faris and Kelly, but had nothing to do with the failure of the other radios to receive and output the call. A technician diagnosing the above described faults would need to track down the complete communications path for each radio individually to determine why that radio did not receive the call.

The communications assurance analysis techniques described herein overcome the diagnostic problem by providing a visual representation of the entire communications path for each device, from call initiator to all intended call receivers, including intermediate network infrastructure. Metrics related to all elements (e.g. transmitting radio, receiving radios, network infrastructure, etc.) are aggregated for a call. These metrics are displayed in a call stage tree that visually represents the level of degradation in each stage of the tree. Problems that affect single and/or multiple radios are readily identifiable from the visualization.

A method is provided. The method includes retrieving, by a communications assurance analysis system, performance points of a plurality of stages of a single radio call. The method further includes determining a level of degradation for each stage of the plurality of stages of the single radio call based on the performance points. The method further includes displaying a visualization of each stage of the single radio call, the visualization in order of a communication path between an initiator of the single radio call and at least one recipient of the single radio call, wherein the visualization for each stage of the plurality of stages is based on the level of degradation for the stage.

In one aspect of the method, determining the level of degradation for each stage of the plurality of stages based on the performance points further comprises retrieving a set of parameters associated with each stage, the set parameters indicative of types of failures within the stage, weighting each parameter of the set of parameters based on the performance points to create a set of weighted parameters, and combining the set of weighted parameters, wherein the level of degradation of the stage is based on the combination of the set of weighted parameters. In one aspect, the method further includes displaying, on the visualization, a control to play the single radio call as transmitted, and when the control to play the single radio call is activated, output the recording of the radio call as sent by the initiator of the single radio call. In one aspect, the method further includes displaying, on the visualization, a control to play the single radio call as received by the at least one recipient of the single radio call, and when the control to play the single radio call is activated, retrieve a recording of the single radio call as received by the at least one recipient of the single radio call, and output the recording of the radio call as received by the at least one recipient of the single radio call.

In one aspect, the method further includes displaying a timeline of a plurality of single radio calls, the timeline allowing a user to select an individual radio call from the plurality of single radio calls and providing the visualization for the selected individual radio call. In one aspect of the method the plurality of stages of a single radio call comprises at least one of a radio frequency transmission, an inbound radio frequency reception, and an outbound radio frequency transmission. In one aspect, the method further includes retrieving the level of degradation for each stage of the plurality of stages of the single radio call for a plurality of single radio calls, retrieving the level of degradation for each stage of the plurality of stages of the single radio call for a plurality of single radio calls, and computing an overall score based on the level of degradation for each stage for the plurality of single radio calls, wherein the overall score indicates a health of a communications system being analyzed by the communications assurance analysis system.

A system is provided. The system includes a processor and a memory. The memory contains a set of instructions thereon that when executed by the processor cause the processor to retrieve, by a communications assurance analysis system, performance points of a plurality of stages of a single radio call. The instructions further cause the processor to determine a level of degradation for each stage of the plurality of stages of the single radio call based on the performance points. The instructions further cause the processor to display a visualization of each stage of the single radio call, the visualization in order of a communication path between an initiator of the single radio call and at least one recipient of the single radio call, wherein the visualization for each stage of the plurality of stages is based on the level of degradation for the stage.

In one aspect of the system, the instructions to determine the level of degradation for each stage of the plurality of stages based on the performance points further comprises instructions to retrieve a set of parameters associated with each stage, the set parameters indicative of types of failures within the stage, weight each parameter of the set of parameters based on the performance points to create a set of weighted parameters, and combine the set of weighted parameters, wherein the level of degradation of the stage is based on the combination of the set of weighted parameters. In one aspect of the system, the memory further comprises instructions to display, on the visualization, a control to play the single radio call as transmitted, and when the control to play the single radio call is activated, retrieve a recording of the single radio call as sent by the initiator of the single radio call and output the recording of the radio call as sent by the initiator of the single radio call. In one aspect of the system, the memory further comprises instructions to display, on the visualization, a control to play the single radio call as received by the at least one recipient of the single radio call, and when the control to play the single radio call is activated, retrieve a recording of the single radio call as received by the at least one recipient of the single radio call and output the recording of the radio call as received by the at least one recipient of the single radio call.

In one aspect of the system, the memory further comprises instructions to display a timeline of a plurality of single radio calls, the timeline allowing a user to select an individual radio call from the plurality of single radio calls and provide the visualization for the selected individual radio call. In one aspect of the system, the plurality of stages of a single radio call comprises at least one of a radio frequency transmission, an inbound radio frequency reception, and an outbound radio frequency transmission. In one aspect of the system, the memory further comprises instructions to retrieve the level of degradation for each stage of the plurality of stages of the single radio call for a plurality of single radio calls and compute an overall score based on the level of degradation for each stage for the plurality of single radio calls, wherein the overall score indicates a health of a communications system being analyzed by the communications assurance analysis system.

A non-transitory processor readable medium containing a set of instructions thereon is provided. The instructions on the medium, when executed by a processor, cause the processor to retrieve, by a communications assurance analysis system, performance points of a plurality of stages of a single radio call. The instructions on the medium further cause the processor to determine a level of degradation for each stage of the plurality of stages of the single radio call based on the performance points. The instructions on the medium further cause the processor to display a visualization of each stage of the single radio call, the visualization in order of a communication path between an initiator of the single radio call and at least one recipient of the single radio call, wherein the visualization for each stage of the plurality of stages is based on the level of degradation for the stage.

In one aspect of the medium, the instructions to determine the level of degradation for each stage of the plurality of stages based on the performance points further comprises instructions to retrieve a set of parameters associated with each stage, the set parameters indicative of types of failures within the stage, weight each parameter of the set of parameters based on the performance points to create a set of weighted parameters, and combine the set of weighted parameters, wherein the level of degradation of the stage is based on the combination of the set of weighted parameters. In one aspect, the medium further comprises instructions to display, on the visualization, a control to play the single radio call as transmitted, and when the control to play the single radio call is activated, retrieve a recording of the single radio call as sent by the initiator of the single radio call and output the recording of the radio call as sent by the initiator of the single radio call. In one aspect, the medium further comprises instructions to display, on the visualization, a control to play the single radio call as received by the at least one recipient of the single radio call, and when the control to play the single radio call is activated, retrieve a recording of the single radio call as received by the at least one recipient of the single radio call and output the recording of the radio call as received by the at least one recipient of the single radio call.

In one aspect, the medium further comprises instructions to display a timeline of a plurality of single radio calls, the timeline allowing a user to select an individual radio call from the plurality of single radio calls and provide the visualization for the selected individual radio call. In one aspect, the medium further comprises instructions to retrieve the level of degradation for each stage of the plurality of stages of the single radio call for a plurality of single radio calls and compute an overall score based on the level of degradation for each stage for the plurality of single radio calls, wherein the overall score indicates a health of a communications system being analyzed by the communications assurance analysis system.

Further advantages and features consistent with this disclosure will be set forth in the following detailed description, with reference to the figures.

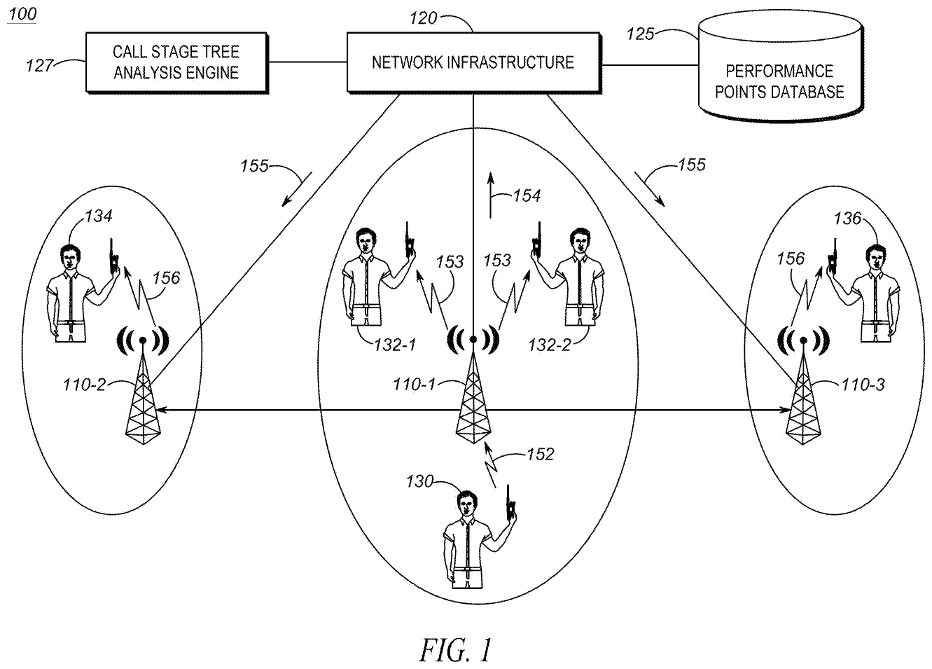

FIG. 1 is a high level example of a communications network 100 that may utilize the communications assurance analysis techniques described herein. Network 100 is intended to be a high level description of a communications network and every single element of the network is not shown. A person of skill in the art would understand that each of the elements described with respect to FIG. 1 may be integrated within a single device or distributed amongst multiple devices.

System 100 may include radio access network (RAN) sites 110-1-3. Each of the RAN sites may receive RF transmissions from subscriber devices. The communications may be sent to network infrastructure 120. The RAN sites may also receive communications from the network infrastructure and transmit those communications, via RF to recipient subscriber devices.

System 100 may include network infrastructure 120 connected to the RAN sites 110-1-3. Although not shown, the network infrastructure may include a packet data network, cloud compute cluster, dispatch consoles, repeaters, and various databases. One such database may be a performance points database 125. The performance points database may store performance metric for all devices within the system 100 (e.g. any faults on any portion of any network element). Performance points will be described in further detail below.

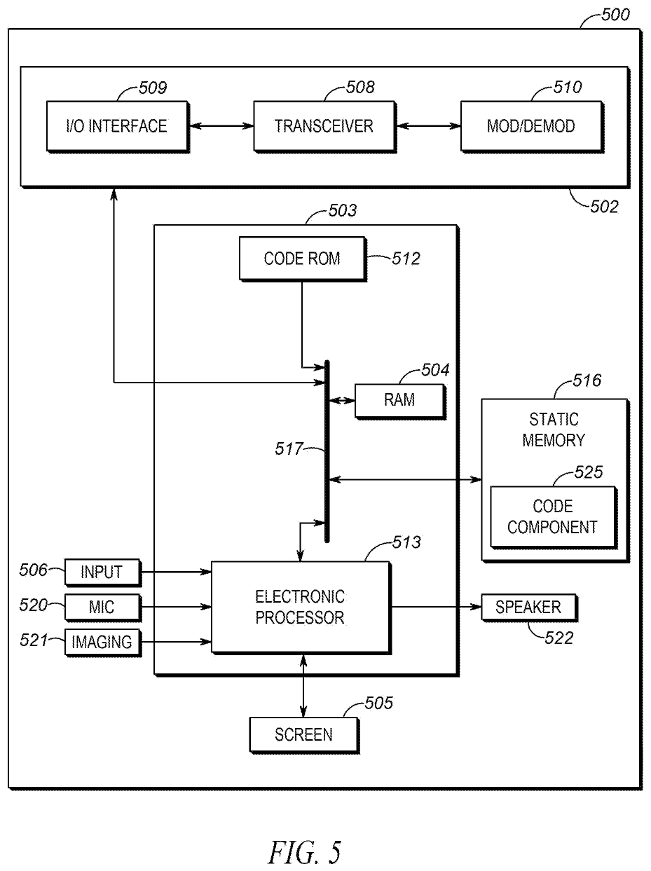

System 100 may include a number of subscriber devices. An example of a hardware device that may implement a subscriber device is shown with respect to FIG. 5. Subscriber devices may be devices such as radios (e.g. car mounted radio, walkie-talkie, etc.) that may be utilized by public safety responders to communicate with each other. Subscriber device 130 may be a subscriber radio that is initiating a call to other members of a talkgroup. Subscriber devices 132-1,2 may be radio devices affiliated with the talkgroup that is part of the call being made by subscriber device 130. Subscriber devices 130 and 132 may all be within the coverage area of RAN 110-1.

Subscriber device 134 and subscriber device 136 may be subscriber devices located within the coverage area of RAN 110-2 and 110-3 respectively. Subscriber devices 134, 136 may also be affiliated with the talkgroup that subscriber device 130 is attempting to communicate with.

In operation, a user of subscriber device 130 may press a PTT button on the device to initiate a call 152 to the talkgroup. The user may, in some cases, need to wait for a talk permit tone before speaking. The user of subscriber device 130 may then begin speaking. The audio may be captured by a microphone of the device. The audio may then be transduced into an electrical signal. The transduced electrical signal may then be digitized prior to transmission. The digitized signal may then be RF modulated and sent to the RAN 110-1. These four steps may comprise the transmit portion of the call stage tree.

The incoming call 152 may be received by the RAN 110-1 through an inbound RF receiver on the site. The inbound RF may be converted back to the digitized audio. The digitized audio may be converted to an outbound RF signal and sent 153 to subscriber devices 132-1,2 that are affiliated with the talkgroup and also connected to RAN 110-1. The digitized audio may then be sent 154 to the network infrastructure 120 in order for the digitized audio to be repeated to other RAN sites 110-2,3.

The network infrastructure 120 may duplicate (e.g. repeat) the received digitized audio 154 and send 155 the digitized audio to the other RAN sites 110-2,3. Once the digitized audio is received by the RAN sites 110-2,3, those sites may convert the digitized audio into an RF signal and transmit the RF signal 156 to subscriber devices 134, 136 within the coverage area of those sites. The receive RF signal, repeat as necessary, and retransmit RF signal steps may be referred to as the repeater stages of the call stage tree.

The subscriber devices 132, 134, 136 may receive the RF signal through an RF transceiver of the device. The RF signal may then be converted back to a digitized signal. The digitized signal may be converted to an audio waveform. Finally, the audio waveform may be output through a speaker of the subscriber device in order to allow the users of the device to hear the audio transmitted by subscriber device 130. These four steps of receiving the RF signal and converting it back to the sent audio may be referred to as the receiver portions of the call stage tree. The call stage tree will be described in further detail below.

While all of the stages of the call stage tree are being executed, performance points are being generated for each device. For example, each subscriber device may be collecting metrics on each stage. Examples of such metrics are described further below. These metrics may be collected on the subscriber devices themselves, and periodically stored in the performance points database. Likewise, metrics from the RAN sites and the network infrastructure may also be collected and periodically stored in the performance points database. What should be understood is that all performance point metrics for all entities within system 100 are made available in the performance points database 125 at some point in time and are available for use according to the techniques described herein. For purposes of ease of description, the curated performance point metrics, as collected by the system, may generally be referred to as system data.

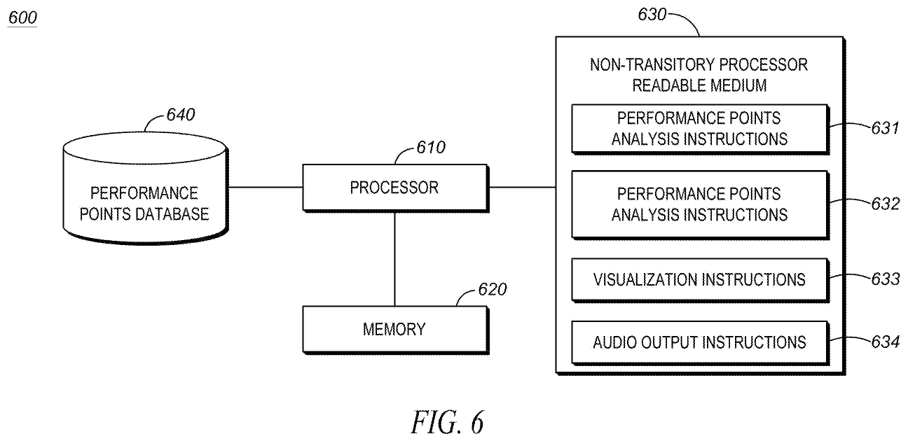

System 100 also includes a call stage tree analysis engine 127. The call stage tree analysis engine may be implemented by a device such as the one described with respect to FIG. 6. The call stage tree analysis system may utilize the data stored in the performance points database 125 to provide a visual representation of the call placed by the subscriber device 130 to aid in determining which subscriber devices may have had issues receiving the call and the root cause for those issues.

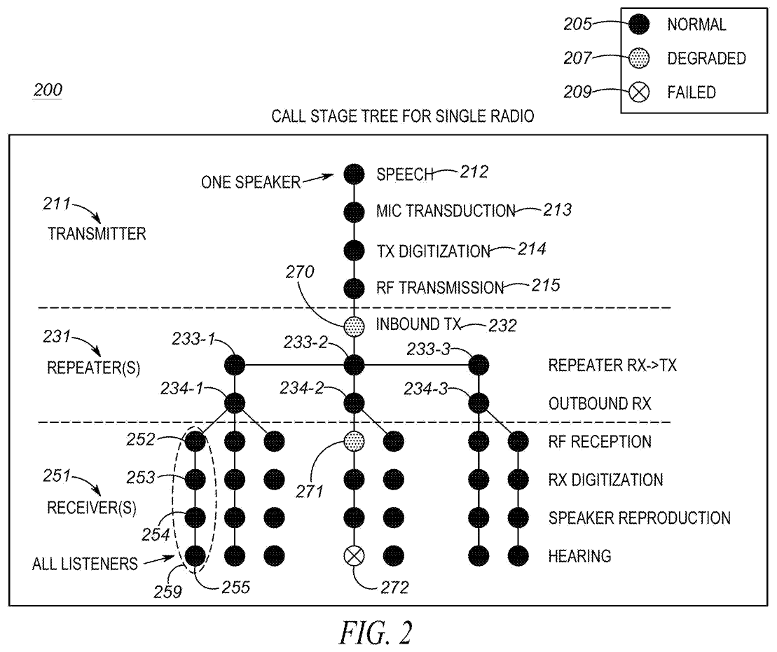

FIG. 2 depicts an example of a call stage tree for a single radio call 200. Each stage of the call is associated with an indicator that shows if that particular stage of the call was normal, degraded, or failed. In the present example, a stage that is normal is depicted with a solid 205 circle. A stage that is degraded, but still functional, is depicted with a dotted 207 circle. A stage that has failed is indicated with an X 209 enclosed by a circle. It should be understood that these examples are presented as one possible way of depicting the conditions and are limited by the non-color requirements of the drawings. In another possible implementation, normal operation may be depicted by a green circle, degraded operation by a yellow circle, and failed operation by a red circle. What should be understood is that the normal/degraded/failure status is depicted visually for each stage in a way that can be easily understood for the overall end to end call.

As explained above with respect to FIG. 1, a single radio call may be broken down into three main sections. The first section is the transmitter 211 section. The transmitter section covers call stages that are dependent on the functionality of the subscriber device that is initiating the radio call. The second section can be referred to as the repeater(s) section 231. The repeaters section includes call stages associated with the communications network. The final section may be referred to as the receiver(s) section. The receiver(s) section 251. The receivers section includes call stages associated with each receiver subscriber device in the talkgroup. As should be clear for the call stage tree depicted in FIG. 2, for a single radio call there is a single transmitter, a varying number of repeater nodes, depending on the particular architecture of the communications network, and one or more receiver subscriber devices.

As will be explained below, each of the stages has several parameters (e.g. metrics) that relate to the operation of that stage. The tables below set forth examples of those parameters. Each parameter is also associated with an indication of how the parameter is measured. Finally, each parameter is associated with a weight. A higher weight means that a failure of that particular parameter indicates that the entire stage may be in a failure mode, while a low weight means that the stage may still be operational, but operating with some level of degradation.

It should be understood that degradation at each stage can range from complete normal operation to complete failure. Normal operation may indicate all receiver devices were able to receive the communication, while complete failure at any given stage may indicate that no receivers beyond that stage were able to receive the communication. For example, a complete failure of any of the stages in a given stage means that any recipient further down the line of the complete failure would not receive the call. A complete failure in any stage in the transmitter section 211 would mean that no other members of the talkgroup would receive the call. A compete failure in the receiver section 251 means that one particular radio may not receive the call. A complete failure in the repeater section may cause some subset of the members of the talkgroup to not receive the call.

As will be discussed in further detail below, each stage may include different parameters with different weights. In some cases, failure of an individual parameter may not cause the stage to fail. However, failure of another parameter (which may also not itself alone cause the stage to fail), when combined with the original failure may cause the overall stage to fail. Likewise, failures of parameters in different stages may not individually cause the overall call to fail, but the combinations of failure in multiple stages may cause the overall call to fail.

The locations of failure within the call stage tree can aid a technician when attempting to resolve issues, depending on the location of the failure. For example, consider a case where there is a degradation 270 within the inbound reception of a call at the base station, but the base station was able to recover from the failure through error correction. There may also have been a failure with the RF reception 271 at a single receiver, but that failure may have simply been a high error rate that was recovered from by producing slightly garbled speech. There may have been a complete failure 272 resulting in no audio at the receiver device (e.g. volume set to zero).

In this particular scenario, even though there was degradation at the inbound reception stage, that would impact every single radio receiving the call, because the failure was recovered, the technician may choose to focus recovery efforts on the specific device that actually did not receive the call. However, if the failure that occurred was on the inbound reception and it could not be recovered this would prevent any radio from receiving the call, regardless of any specific problem with a specific radio. As such, recovery efforts may be focused on the call stage that is having the greatest impact to the greatest number of users. The visualization provides the technician with a quick and easy way to determine where the problems lie, and which problem affect the greatest number of users.

The types and locations of the failures is what contributes to the overall system health score. As will be described in further detail below, an overall system health score may be calculated. Failures that affect a small number of call recipients will have less of an impact than failures that affect a large number, if not all, of the call recipients.

In the transmitter stages 211, the first stage is the speech 212 stage. The speech stage is the actual capture of the audio from the user by the microphone. The speech stage has several parameters (e.g. metrics) that are described with respect to Table 1 below. It should be understood that these parameters for the speech stage are examples of types of speech metrics and the techniques described herein are not limited to these particular metrics.

TABLE 1
Speech Stage

| Parameter | How Measured | Weight |
|---|---|---|
| Low/Indirect Voice | Average/Median Level | Medium |
| Ambient/Wind Noise | Audio Processing Output | Medium |
| Yelling/Agitation | Clipping/Distortion/ | Medium |
| | SNR | |

The first parameter shown in Table 1 is Low/Indirect voice. This parameter measures if the person speaking into the subscriber device is talking with a soft voice and as such the subscriber device may have difficulty detecting the speech. The same thing could happen if the speaker is not speaking directly into the microphone. This condition might be detected by measuring the average/media audio signal level of the speech. It may have a medium weight, as someone speaking with a soft voice might still be detectable by the subscriber device and is not guaranteed to cause the stage to fail.

The second parameter shown is ambient/wind noise. If the environment is high in ambient noise, it may be difficult for the audio to be captured as it may be masked by the ambient noise. The parameter is measured using the audio processing output of the subscriber device. Subscriber devices may be equipped with audio processing software (e.g. noise cancelation software, etc.) that may be used to detect the level of ambient noise/wind noise. The ambient/wind noise parameter may have a medium weight as a failure may result in degraded audio being captured, but would not prevent audio capture completely.

The third parameter is if the audio includes yelling/agitation. This may be measured by determining if the audio input is being clipped, distorted, or has a high signal to noise ratio. As with the other parameters, this parameter may have a medium weight, because failure here would not cause the entire stage to fail, but rather may result in degraded quality of the captured audio.

The second stage in the transmitter stages 211 is the microphone transduction stage 213. The microphone transduction stage is the conversion of the audio captured in the previous stage into an electrical signal. The parameters associated with the microphone transduction stage are described with respect to Table 2 below. It should be understood that these parameters for the microphone transduction stage are examples of types of microphone transduction metrics and the techniques described herein are not limited to these particular metrics.

TABLE 2
Microphone Transduction Stage

| Parameter | How Measured | Weight |
|---|---|---|
| RSM Use | System Data | Low |
| Noise Cancelation/Multi | Enabled/Mode | Medium |
| Microphone | | |
| Port Blockage | Audio Processing Output | High |
| Mic Failure | Audio Processing Output | High |
| Howling Effects | Howling Detector | Low |

The first parameter shown is if the call initiator is using a radio speaker microphone (RSM) (e.g. a microphone often pinned to the responder's collar or lapel). This is measure by system data, which is just configuration information stored, for example, in the performance point database. What should be understood is that system data represents static/dynamic data that might be stored for each user/element described with respect to FIG. 1. Here system data could indicate with a yes/no field if the transmitter is equipped with a RSM.

Use of an RSM is a risk factor as users often times do not speak directly into the device. However, this parameter is given a low weight, as not speaking directly into the RSM does not necessarily mean that the microphone will not be able to function properly.

The second parameter is if noise cancelation/multi-microphones are equipped. This may be measured by determining if multi-microphone features are enabled and in what mode. Noise cancelation and multi-microphone may ensure that the audio signal is as clean as possible, thus ensuring that the conversion to an electrical signal is correct. This parameter has a medium weight, as an improper configuration is not necessarily going to cause the stage to fail.

The third parameter is port blockage (e.g. physical input to the microphone is blocked). This may be measured by the audio processing software output, as described above. For example, if the port is blocked, there may be no microphone transduction that occurs, as the microphone is blocked from receiving any audio. As shown, the weight of this parameter is high, because a blocked port generally results in the microphone transduction stage failing.

The fourth parameter is microphone hardware failure. Failure can again be determined by the audio processing software output. Just as with port blockage, the microphone hardware failure has a high weight because failure of this parameter likely means that the entire microphone transduction stage is going to fail.

The fifth parameter is a howling parameter. Howling occurs when there is feedback between the output speaker of a device, such as a RSM, and the microphone. This feedback causes a sound very similar to a howl, and makes the audio unintelligible. Subscriber devices may be equipped with howling detectors to measure this condition. As the howling makes the audio difficult, but not impossible, to understand, the howling effects are given a low weight, as by themselves are not likely to cause the entire microphone transduction stage to fail.

The third stage in the transmitter stages 211 is the Transmit Digitization stage 214. The transmit digitization stage is the conversion of the analog electrical signal from the microphone transduction stage into a digital signal. This may not only include performing an analog to digital conversion of the electrical signal, but also preparing the digital baseband signal (e.g. proper encoding, packetizing, etc.) that will eventually be modulated by a RF signal for wireless transmission. The parameters associated with the transmit digitization stage are described with respect to Table 3 below. It should be understood that these parameters for the transmit digitization stage are examples only of types metrics and the techniques described herein are not limited to these particular metrics.

TABLE 3
Transmit Digitization Stage

| Parameter | How Measured | Weight |
|---|---|---|
| Firmware Version | System Data | Low |
| TX Configuration | TGID/Freq./Type | High |
| AFC Availability | Set/Unset | Low |
| Channel Access/ | PTT codes | High |
| Congestion | | |
| TX Digital Hardware | PTT codes | High |
| failure | | |

The first parameter shown is the firmware version of the subscriber device, which can be measured by accessing the system data (e.g. data stored about subscriber devices, etc.). The firmware is given a low weight, as subscriber devices are generally compatible with multiple different firmware versions, and a mismatch is not likely to cause the entire stage to fail.

The second parameter is the transmit configuration data, which determines information such as the assigned talkgroup, frequency in use, and type of transmission (e.g. conventional, trunked, etc.). This parameter is given a high weight as it does have the ability to cause the stage to fail, but it is also possible that it would just result in degraded performance. The parameter includes Network access codes, subaudbile signaling etc. This parameter is perhaps the most significant factor of this particular stage with the highest risk from historical measure.

The third parameter is if Automatic Frequency Control (AFC) is available. Automatic frequency control is measured by either being set or unset on the subscriber device. Automatic frequency control is used to ensure that the radio is transmitting on the correct frequency. As AFC is used as a check, rather than to set the frequency, the weight of this parameter is low. It would be expected that the subscriber device would transmit on the correct frequency, even absent the presence of AFC. This parameter is also a pre-indicator of hardware failure. As the radio crystal ages, the frequency will start drifting. AFC will compensate more and more until it cannot any further. Therefore, radios exhibiting high AFC correction factors are at risk for not getting channel access because their synthesized frequency is too far from what the network will accept. The impact of this issue is different between Astro, PCR, Tetra owing to the differences in how the protocols are setup to deal with it. Because of this a technician looking at this value may interpret the severity differently depending on what type of users he is analyzing. It is still ‘Low’ because a trend would be established letting the analysis point to the problem before it becomes critical.

The fourth parameter is channel access/congestion. As mentioned above, prior to speaking, in some implementations, the speaker must wait for a talk permit tone prior to speaking. If such a talk permit tone is not received because the communications channel is blocked due to congestion, such a condition may be reported by PTT codes (e.g. error code indicating the channel is blocked) and can be measured using the PTT codes. As expected, the weighting of this parameter is high, because a failure of this parameter means the entire transmit digitization stage will fail, as no audio can be sent.

The fifth parameter is transmit digital hardware failure. This failure can be detected by the PTT codes described above. Just as above, failure of the transmit digital hardware means that no audio is transmitted. Thus this parameter is given a high weight, because failure means the entire transmit digitization stage will fail.

The fourth stage in the transmitter stages 211 is the RF Transmission stage 215. The RF transmission stage takes the digitized signal from the transmit digitization stage and converts it into an RF signal that can be transmitted over the air wirelessly. The parameters associated with the RF transmission stage are described with respect to Table 4 below. It should be understood that these parameters for the RF transmission stage are examples only of types metrics and the techniques described herein are not limited to these particular metrics.

TABLE 4
RF Transmission Stage

| Parameter | How Measured | Weight |
|---|---|---|
| VCO Frequency | Repeater and AFC data | Low |
| Generation | | |
| Antenna/Proximate | Spur Technique | Medium |
| Metallic Objects | | |
| RF TX hardware failure | PTT codes | Medium |
| Radio Orientation | Accelerometer | Low |
| Location | Repeater Data | High |

The first parameter is Voltage Controlled Oscillator (VCO) frequency generation. This may be measured from data received from the repeater and system data, such as that provided by the AFC. This parameter has a low weight, as failure does not necessarily mean the stage will fail, as the base station receiving the RF signal may be able to correct for errors. Thus, a degradation of the VCO frequency generation does not necessarily mean the stage will fail.

The second parameter is the antenna on the subscriber device may be incorrect. For example, the user of the subscriber device may have replaced the antenna with an unapproved antenna or the antenna may be broken. This condition may be measured using a spur technique, which is a RF technique used to determine if a device antenna is functioning as designed. This parameter is given a medium weight, as although degradation of this parameter could cause the entire stage to fail, it is also possible that failures at this stage could be corrected at a later stage.

The third parameter is RF transmit hardware failures. These failures may be measured through the use of PTT codes. These types of failures may have a medium weight, as it is possible such failures are correctable by a device receiving the RF transmission.

The fourth parameter is radio orientation. Due to the polarized nature of RF signals, the direction the subscriber device could have an impact on the RF transmission. This parameter may be measured by an accelerometer on the subscriber device. The orientation parameter may have a low weight, as it is unlikely an incorrect orientation of the subscriber device will cause the entire stage to fail.

The next several stages discussed will be the repeater(s) stage 231. The repeater stage consists of the base station receiving an inbound RF signal that was transmitted from the subscriber device in the RF transmission stage. The RF signal is decoded into a digital signal and propagated to any repeaters that include subscriber devices affiliated with the talkgroup. Each of these repeaters may convert the signal back to an RF signal, and then transmit to their own area of coverage. What should be understood is that unlike the transmitter stages, where a complete failure of any stage means no devices will receive the call, here as failure of a stage may mean that a subset of subscriber devices may fail to receive the radio call.

The fifth stage in the repeater stages 231 is the receiving of the inbound RF transmission 232 from the RF transmission stage 215. The repeater may take the received inbound RF transmission and convert the signal to a digital signal. The parameters associated with this stage, are described below with respect to table 5. It should be understood that these parameters for the receive inbound transmission stage are examples only of types metrics and the techniques described herein are not limited to these particular metrics.

TABLE 5
Inbound TX Reception Stage

| Parameter | How Measured | Weight |
|---|---|---|
| Propagation | Repeater Statistics Data | Low |
| Interferers | Repeater Statistics Data | Medium |
| Repeater RX | Codeplug Configuration | High |
| Configuration | | |

The first parameter is propagation related parameters. The ability for the repeater to receive a good RF signal to convert to a digital signal is based on the quality of the received RF signal. Some characteristics of a good RF signal can be line of sight the transmitter, objects between the repeater and the transmitter, and weather. This information can be measured by the repeater itself, and as such can be reported by the repeater. A properly designed network should be able to recover from problems with this parameter, so it is given a low weight, as a failure would likely be recoverable, and not cause the entire stage to fail.

The second parameter is if there are any interferers. Interferers can degrade the RF signal such that it may or may not be recoverable by the repeater. The presence of interferers may be reported by the repeater itself. This parameter is given a medium weight because it is possible that failure of this parameter may cause the entire stage to fail.

The third parameter is if there are setup RX configuration errors in the repeater configuration that may have occurred on initial deployment of the system, a subsequent upgrade or maintenance interaction affecting one or more users due to a bad RX system setting choice. This parameter is given a high weight as incorrect configuration may cause the stage to fail.

The sixth stage in the repeater stages 231 is the repeating of the digital signal 233-1 . . . 3 from the inbound transmit stage 232. As shown in FIG. 2, there are three repeaters. The digital signal is propagated to each repeater for conversion into RF to be sent out. It should be understood that three repeaters are shown by way of example only. An actual system may have more or fewer repeaters. The parameters associated with this stage are described below with respect to table 6. It should be understood that these parameters for the repeater RX-TX stage are examples only of types metrics and the techniques described herein are not limited to these particular metrics.

TABLE 6
Repeater RX−>TX Stage

| Parameter | How Measured | Weight |
|---|---|---|
| Repeater Status (up/down) | Repeater Data | High |
| Repeater Rx-Tx | Codeplug configuration | High |
| Configuration | | |

The first parameter shown is the repeater status, which indicates if the repeater is functioning or not (e.g. up/down). This information may be reported by the repeater itself, with no indicated status being equivalent to the repeater being down. This parameter has a high weight, because if the repeater is down, it cannot send the radio call out to subscriber devices located in its geographic area, and as such a repeater being down will cause a failure at this stage for any repeaters that are down.

The second parameter is if there are setup RX-TX configuration errors in the repeater configuration that may have occurred on initial deployment of the system, a subsequent upgrade or maintenance interaction affecting one or more users due to a bad RX-TX system setting choice. This parameter is given a high weight as incorrect configuration may cause the stage to fail.

The seventh stage in the repeater stages 231 is the outbound RF transmission stage 234-1 . . . 3 which converts the signal received from the previous stage 233 to an RF signal and sends the RF signal to subscriber devices within the geographic coverage area of the repeater. As above, the example continues with three repeaters. The parameters associated with this stage are described below with respect to table 7. It should be understood that these parameters for the outbound RF transmission stage are examples only of types metrics and the techniques described herein are not limited to these particular metrics.

TABLE 7
Outbound RF Transmission Stage

| Parameter | How Measured | Weight |
|---|---|---|
| Propagation | System Data | Low |
| Interferers | System Data | Medium |
| Repeater Tx | Codeplug configuration | High |
| Configuration | | |

The first parameter is propagation parameters. These parameters may be stored in system data as described above. It should be noted that unlike the propagation parameters in table 5, which are measured by the repeater, the propagation parameters in stage 234 are measured by the subscriber devices, as those are the devices receiving the RF signal. The propagation parameters are given a low weight, as a properly designed system should be able to compensate for things like line of sight, objects, and weather. Thus a failure of this parameter is not likely to cause the entire stage to fail.

The second parameter is interferers. As above, these parameters are measured by the receiving subscriber devices, as those are the devices receiving the RF signal. The interferers parameter is given a medium weight because a failure in this parameter could cause the entire stage to fail.

The third parameter is if there are setup TX configuration errors in the repeater configuration that may have occurred on initial deployment of the system, a subsequent upgrade or maintenance interaction affecting one or more users due to a bad RX-TX system setting choice. This parameter is given a high weight as incorrect configuration may cause the stage to fail.

The next several stages are the receiver stages 251. Each vertical column of four stages 259 are the receive stages for a single subscribe device that is a member of the talkgroup that is receiving the transmitted radio call. As should be clear, a failure or degraded operation of any stage within a single subscriber device will only affect that subscriber device, as opposed to a failure in the transmitter stages 211 which may impact all receiving devices for a failure in the repeater(s) stages 231 which may impact a subset of receiver devices.

For ease of description, the receiver stages will be described with reference to the stages for a single device 259. However, it should be understood that each receiving subscriber device has the same stages.

The eighth stage in the receiver(s) stages 251 is the RF reception stage 252 which receives the RF signal from the repeaters that was sent in the previous stage 234 and converts it to a digitized signal. The RF reception stage 252 is essential the inverse of the operation performed in the RF transmission stage 215, and as such the parameters are similar. The parameters associated with this stage are described below with respect to table 8. It should be understood that these parameters for the RF reception stage are examples only of types metrics and the techniques described herein are not limited to these particular metrics.

TABLE 8
RF Reception Stage

| Parameter | How Measured | Weight |
|---|---|---|
| VCO Frequency | Repeater and AFC data | Low |
| Generation | | |
| Antenna/Proximate | Spur Technique | Medium |
| Metallic Objects | | |
| RF RX Hardware Failure | Radio Error Codes | High |
| Radio Orientation | Accelerometer | Low |
| Location | System Data | High |
| Radio on/off | System Data | High |

The first parameter is VCO frequency generation. This parameter is similar to the parameter described above with respect to the RF transmission stage and is measured similarly, with the exception that repeater data is not used. Again, the parameter is given a low weight, as a failure in this stage is not likely to cause the stage to fail entirely.

The second parameter is the antenna. Just as above, an improper antenna can cause the received RF signal to not be decodable. The measurement may be made using the spur technique described above. The weight of this parameter may be low, as an improper antenna may not cause the entire stage to fail.

The third parameter is the RF receive hardware failure. This may be measured by error codes produced by the subscriber device. This parameter is given a high weight, because the receive hardware has failed, it is likely that the entire stage for this device will also fail.

The fourth parameter is the radio orientation. The radio orientation may determine how well the RF signal is received. This parameter maybe measured by an accelerometer. The parameter has a low weight because the orientation of the radio will likely not cause a complete failure of the stage.

The fifth parameter is the location of the radio, and in particular the received radio signal strength indicator (RSSI) and Bit Error Rate (BER) of the RF signal at the current location the subscriber device. This information may be included as part of the system data. This parameter is given a high weight, as failure for this parameter would like cause the entire stage to fail.

The sixth parameter is if the radio is on or off. This parameter may be measured by the system data, which will store when the subscriber device is on or off. The parameter is given a high weight, because if the device is off, it is guaranteed that the subscriber device will fail this stage.

The ninth stage in the receiver(s) stages 251 is the RX digitization stage 253 which takes signal from the previous stage and converts it back to a digitized audio signal. The RX digitization stage is essentially the inverse of the operation performed in the TX digitization stage 214, and as such the parameters are similar. The parameters associated with this stage are described below with respect to table 9. It should be understood that these parameters for the RX digitization stage are examples only of types metrics and the techniques described herein are not limited to these particular metrics.

TABLE 9
RX Digitization Stage

| Parameter | How Measured | Weight |
|---|---|---|
| Firmware Version | System Data | Low |
| RX Configuration | TGID/Freq./Type | Medium |
| AFC Availability | Set/Unset | Low |
| Feature Interaction | At time of transmission | High |
| RX Digital Hardware | Radio Error Codes | Medium |
| Failure | | |
| Affiliation | System Data | High |

The first three parameters of the RX digitation stage are essentially the equivalent of the first three parameters of the TX digitization stage described with respect to table 3, and will not be repeated here.

The fourth parameter is a feature interaction, such as talkgroup scanning, private calls, etc. This may be measured at the time of transmission. This particular parameter determines if the subscriber device was engaged in another call (e.g. private call, different talkgroup) at the time the current radio call came in. The parameter is given a high weight, because if the subscriber device is engaged in another call, this stage of the current call will fail. This is one of the most interesting failure cases because a user is assigned properly, has good hardware and coverage, but because the user is scanning different talkgroups, they may miss this particular call on this talkgroup. This is difficult to recreate and detect and many times the user doesn't understand the mutual exclusions at work in the radio. Highlighting this condition will be one of the key findings for a user.

The fifth parameter is receiving digital hardware failure. Again, this parameter may be measured by the subscriber device itself through the use of error codes. The parameter is given a medium weight, as a failure of this parameter may mean a degraded output, as opposed to complete failure of this stage.

The sixth parameter may be an affiliation of the subscriber device with the talkgroup for the radio call. This may be measured by the system data which knows which subscriber devices are affiliated with which talkgroups. If the subscriber device is not associated with the talkgroup of the radio call, failure of this stage is guaranteed, and as such the parameter is given a high weight.

The tenth stage in the receiver(s) stages 251 is the speaker reproduction stage 254 which takes signal from the previous stage and converts it back to an audible signal that can be played out by a speaker and heard by a user. The parameters associated with this stage are described below with respect to table 10. It should be understood that these parameters for the speaker reproduction stage are examples only of types metrics and the techniques described herein are not limited to these particular metrics.

TABLE 10
Speaker Reproduction Stage

| Parameter | How Measured | Weight |
|---|---|---|
| RSM Use | System Data | Low |

The first parameter is if the speaker reproducing the audio is a RSM. Determining if an RSM is in use can be done by examining the system data. Use of an RSM may result in lower audio quality, thus making it difficult to hear. However, a properly designed RSM would not make the speech unintelligible cause the stage to fail, so this parameter is given a low weight.

The eleventh stage in the receiver(s) stages 251 is the hearing stage 255 which takes the audio signal from the previous stage to determine if it could be heard and understood. The parameters associated with this stage are described below with respect to table 11. It should be understood that these parameters for the hearing stage are examples only of types metrics and the techniques described herein are not limited to these particular metrics.

TABLE 11
Hearing Stage

| Parameter | How Measured | Weight |
|---|---|---|
| Intelligibility | Mic Feedback | Medium |
| | Intelligibility level | |
| Ambient/Wind Noise | Audio Processing Output | Medium |
| Volume Level | System Data | Medium |
| Adjacent Radios | System Data | Low |

The first parameter may be an intelligibility parameter. This may be measured using feedback from the microphone to determine how intelligible the reproduced audio is. This may have a medium weight because even if the audio is not completely unintelligible, it may be sufficient for degraded output, as opposed to causing the stage to fail completely.

The second parameter may be ambient noise/wind noise. This parameter may be measured by the Audio Processing Output as described above. High levels of ambient noise/wind noise may make understanding the audio output difficult, but not impossible. As such, this parameter may be given a medium weight, because failure of this parameter may not cause the entire stage to fail.

The third parameter may be the volume level. The volume level may be measured by the system data. This parameter may be given a medium weight, because failure will not necessarily cause the stage to fail. A low volume level may be difficult to hear, but could still be heard, so a failure of the stage is not guaranteed.

The fourth parameter is adjacent radios. Adjacent radios may be determined by looking at the system data. Adjacent radios who are also playing out the radio call or even different radio calls could make it difficult to hear the output of the current radio call. This parameter is given a medium weight, because failure does not guarantee that the current radio call cannot be heard and that the stage would fail.

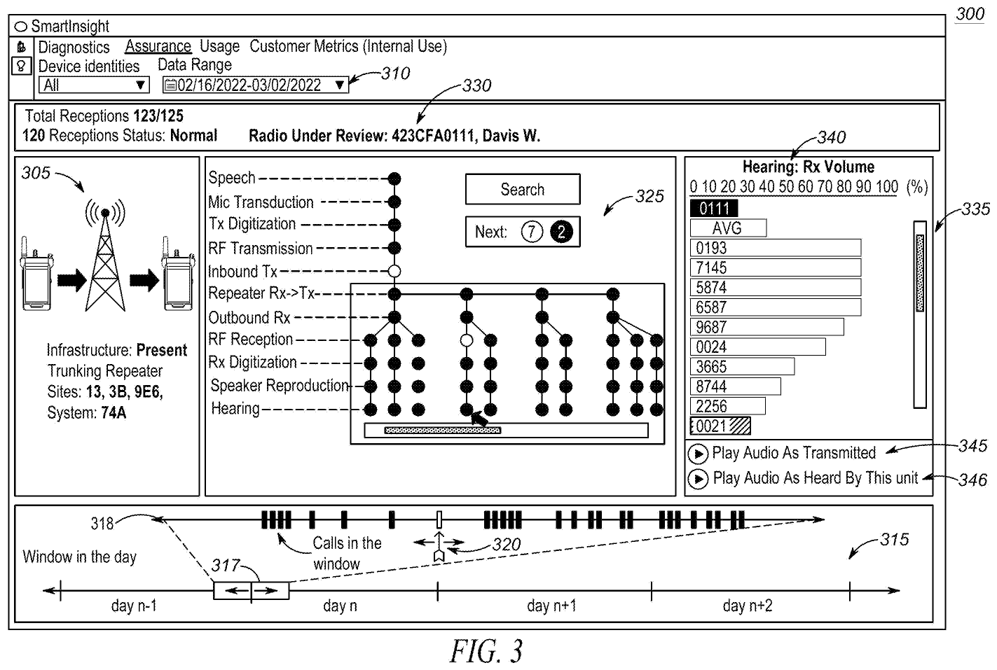

FIG. 3 is an example of a user interface 300 that may be utilized with the techniques described herein. The user interface may provide a way of displaying a timeline of all single radio calls that allows for the system to bring up a selected call stage tree for a particular radio call.

The user interface 300 may include a system architecture section 305 that describes the elements of the system, such as the system described with respect to FIG. 1, that is currently analyzed. As shown, the current system is using infrastructure as indicated by the infrastructure being present. Using infrastructure means the system is operating with one or more RANs. In this particular example, the system includes three repeaters labeled as sites 13, 3B, and 9E6. If the infrastructure is not present, the subscriber devices may be operating in direct mode, which means the subscriber devices communicate directly with one another. The techniques described herein would be suitable for use with direct mode communications, with the difference being the repeater call stages would no longer be present. The system ID for the current system is also shown.

The user may be allowed to enter a date range 310 to identify the time period for radio calls that are to be reviewed. When the user enters a date range, a timeline view 315 of all calls within the date range may be provided. In the example shown, the timeline view is first shown as they days in the date range. The user may then select a window 317 within the days in the date range. This window may then cause a timeline of all calls within the window 318 to be displayed. Each tick on the calls in the window timeline represents an individual radio call.

The user may be allowed to select 320 an individual call in the timeline. For example, the selection may be made by clicking on the specific call in the timeline within the user interface. It should be understood that each tick mark on the calls within the window timeline 318 is an independent call. The calls may all be for different talkgroups or the same talkgroup.

When the user selects an individual call from the call timeline, the call stage tree 325 for the selected call may be displayed. The call stage tree is the same as that which was described with respect to FIG. 2. By examining the call stage tree, and the level of degradation of each node and the specific nodes experiencing degradation provides a user a guide to determine where failures within the communications system are occurring. Looking at the failures across multiple calls can be useful in determining if there is a problem with individual subscriber devices, or with the network as a whole.

For example, if the repeater call stages are experiencing high levels of degradation, regardless of the particular talkgroup of the call, the problem is likely within the repeater components. However, if degradation is occurring for a specific talkgroup, then the problem may be coming from the subscriber devices associated with that specific talkgroup.

Once an individual call is selected, the initiator of that call is known and can be displayed 330. Likewise, all the intended recipients of the call are also known and can be displayed 335. As shown, each bar in the bar graph is labeled with a 4 digit radio identifier. A particular parameter for that receiver may be selected and displayed. In this example, the particular parameter displayed is the receiving volume level 340.

Although the example presented shows the receive volume of the receiving radios being displayed, this is for ease of description only. Any device (e.g. repeaters, etc.) may be selected and the parameters associated with those devices can be displayed. For example, the user could click on one of the repeaters and select a parameter for that repeater to be displayed. This allows the user to drill down to the specific parameters of the specific elements that may be causing degradation of one or more call stages of the overall call stage tree.

The user interface 300 may also include a control 345 to allow playback of the audio, as received by the RAN to be played out via a speaker. As part of receiving the call from the call initiator, the system may record the incoming audio that was received. This recording can be retrieved and output when requested. Likewise, the user may select that the audio as heard by a particular subscriber device 346 be played out. Again playing out this audio includes retrieving the recorded audio and outputting it via a speaker. This can also be captured at the device for further forensic decomposition to determine what was actually said. This may require a separate LTE access method, available on some radios.

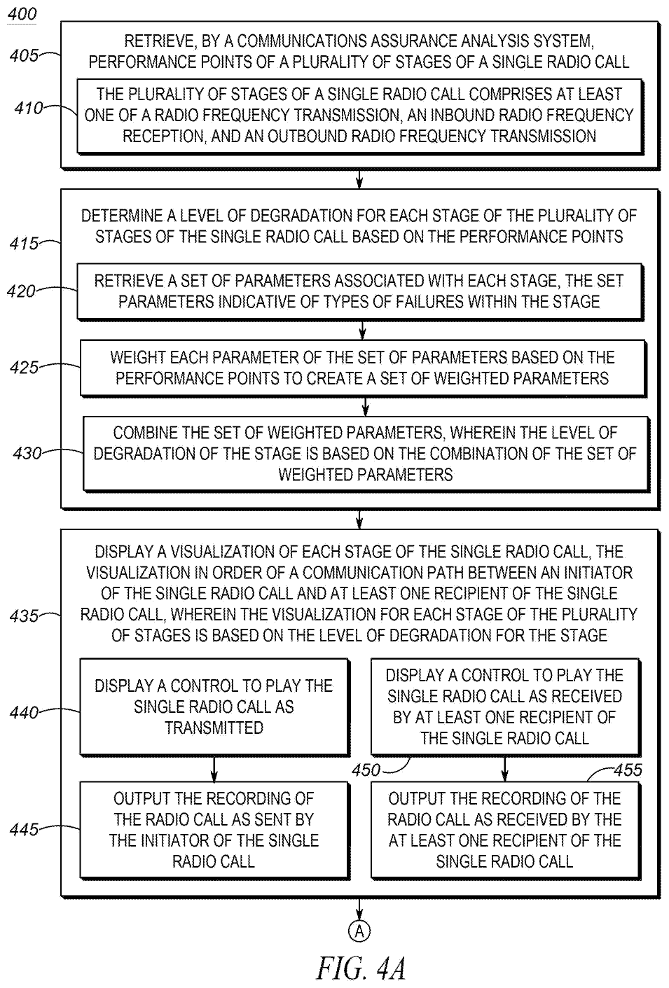

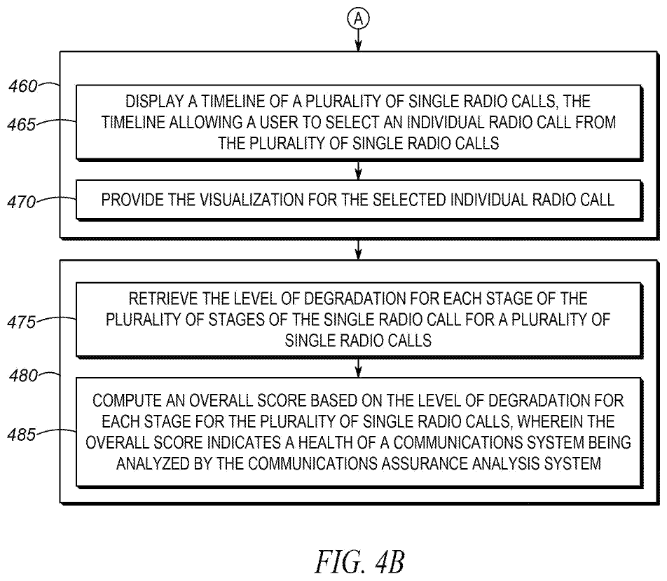

FIGS. 4A and 4B are an example of a flow chart 400 that may implement the communications assurance analysis techniques described herein. In block 405, a communications assurance analysis system may retrieve performance points of a plurality of stages of a single radio call. As explained above, a single radio call from a transmitter may have multiple stages, for example 11 stages, between the initiator of the radio call and receivers of that radio call. Each of those stages has performance points that define if the stage is operating normally, in a degraded mode, or has failed.

In block 410, the plurality of stages of a single radio call comprises at least one of a radio frequency transmission, an inbound radio frequency reception, and an outbound radio frequency transmission. Although there may be many other stages of the call, at minimum the stages will include at least one of a radio frequency transmission (i.e. the transmission from the call initiator), an inbound radio frequency reception (i.e. a RAN site receiving the RF transmission from the call initiator), and a outbound radio frequency transmission (e.g. a RAN site sending the radio call out to all subscriber devices within the RAN). Direct calls, (e.g. ones that do not involve infrastructure) may omit repeater stages as necessary.

In block 415, a level of degradation for each stage of the plurality of stages of the single radio call may be determined based on the performance points. As described above, each stage has performance points, and those performance points are used to evaluate operation of that stage of the call tree. The level of degradation can range from fully operational to completely failed, or somewhere in between. The level of degradation may be used to determine one or more elements that may be causing failure of the single radio call to be received by one or more recipients of the radio call.

In block 420, a set of parameters associated with each stage may be retrieved. The set of parameters are indicative of types of failures within the stage. As describe above with respect to FIG. 2, each stage may have different parameters that reflect the operation of that stage. RF stages have RF type parameters whereas other stages may have different types of parameters. What should be understood is that the set of parameters are the metrics upon which operation of the stage is based.

In block 425, each parameter of the set of parameters is weighted based on the performance points to create weighted parameters. As explained above, depending on the particular stage and the particular parameter, different levels of degradation can occur. Highly weighted parameters may cause the entire stage to fail, whereas parameters that are weighted lower may cause minimal disruption to the stage. The weighting of the parameters is dependent on the particular stage and performance point associated with that stage.

In block 430, the set of weighted parameters may be combined. The level of degradation of the stage is based on the combination of the set of weighted parameters. As described above, the overall combination of the weighted parameter determines the degradation of the stage. If many low weighted parameters are combined, the overall degradation of the stage may be low. One the other hand, a single highly weighted parameter may result in complete failure of the stage. What should be understood is that each parameter for a stage may not be equivalently important for that stage.

In block 435, a visualization of each stage of the single radio call may be displayed. The visualization may be in order of a communications path between an initiator of the single radio call and at least one recipient of the single radio call. The visualization for each stage of the plurality of stages is based on the level of degradation for the stage. An example visualization is shown with respect to FIG. 2. Looking at the visualization may be useful in determining at which points the single radio call is failing. For example, a complete failure of one of the stages from the radio call initiator may mean that no one receives the single radio call. A partial failure in the repeaters stages may mean a subset of receivers do not receive the single radio call. A failure of a stage in an individual device may mean only that device does not receive the single radio call.

As part of an overall user interface, in block 440, a control to play the single radio call as transmitted may be presented. For example, the control to play the single radio call as shown with respect to FIG. 3. When activated the single radio call may be played.

Block 445 describes how the single radio call is played. When the control is activated, a recording of the single radio call as sent by the initiator of the single radio call may be retrieved. The recording of the radio call as sent by the initiator of the call may then be output. The output may occur through a speaker attached to a computing device, such as the ones depicted with respect to FIGS. 5 and 6. It should be understood that the system described with respect to FIG. 1 may make recordings of the radio call as initiated for later playback.

As part of an overall user interface, in block 450, a control to play the single radio call as received by at least one recipient of the radio call may be provided. For example, the control to play audio as heard by a specific unit as shown with respect to FIG. 3. When activated the single radio call, as received by the selected unit may be played.

Block 455 describes how the single radio call as received is played. When the control is activated, a recording of the single radio call as received by the selected recipient is retrieved. The retrieved recording may then be output. The output may occur through a speaker attached to a computing device, such as the ones depicted with respect to FIGS. 5 and 6. It should be understood that the system described with respect to FIG. 1 may make recordings of the radio call as received by each unit for later playback.

The previous blocks have been described in terms of a call stage tree for a single radio call. However, a user interface may be provided that aggregates multiple single radio calls. Such a user interface is depicted in FIG. 3, in which the call timeline allows the user to select an individual call stage tree from multiple radio calls. Block 460 covers several steps to display such a timeline.

In block 465, a timeline of a plurality of single radio calls. For example, the individual call stage trees can be aggregated to appear as a timeline such as the one depicted in FIG. 3. The timeline may allow the user to select an individual radio call from the plurality of single radio calls. For example, the selection may be by way of clicking on an individual call stage tree.

In block 470, the visualization for the single radio call (e.g. the call stage tree) for the selected individual radio call may be displayed to the user. As shown in FIG. 3, the user has selected an individual radio call, and the call stage tree for that call has been displayed. Selecting a different call may case the call stage tree for that call to be displayed.

In block 475, the level of degradation for the entire system or a plurality of calls may be determined. The description thus far has been in terms of level of degradation for a single call stage tree. However, a level of degradation over all call stage trees for a system such as the one described with respect to FIG. 1 may also be computed.

In block 480, the level of degradation for each stage of the plurality of stages of the single radio call for a plurality of single radio calls may be retrieved. In other words, the level of degradation of each stage for all radio calls within the system may be retrieved to determine the performance of the overall system.

In block 485, an overall score based on the level of degradation for each stage for the plurality of single radio calls may be computed. The overall score indicates a health of a communications system that is being analyzed by the communications assurance analysis system.

The computation of the overall score may take into account many factors. For example, the weighted parameters for each stage of the call tree for each individual call. Because each individual call may be to talkgroups that have different numbers of members associated with it, the size of the call may also be factored in when calculating an overall score, such that failure a small radio call (e.g. 5 member talkgroup) is not weighted as heavily as a call with a larger number of talkgroup members.

Repetition of failures of particular stages can be taken into account. For example, repeated failures within the repeater portions of the call stage trees may indicate a bigger problem that single failures of individual transmitter and/or receiver devices. Problems occurring with the same user may indicate that the overall system score should not be lowered as the problems are not system wide, but for a small set of subscriber devices.

The overall score may then be used to detect failures in the system. For example, log terms and short term scores may be maintained for comparison. Any rapid departure from the mean overall score may indicate a new problem is occurring and should be investigated. The overall score may also be used to compare operation between two different communications systems as part of a benchmarking effort. The overall score may include links in a browsing tool that allow the user to click on items that are causing the overall score to be reduced. Those links may then bring up a single call stage tree, such as that depicted with respect to FIG. 3, in order for the user to drill down into the issue that are causing the low overall score.

FIG. 5 is an example of a device 500 that may implement the subscriber devices according to the techniques described herein. The device 500 may be, for example, embodied in the devices 130, 132, 134, 136 described with respect to FIG. 1. Communication device 500 may be a distributed communication device across two or more of the foregoing (or multiple of a same type of one of the foregoing) and linked via a wired and/or wireless communication link(s). In some embodiments, the communication device 500 (for example, the mobile device of the unknown location caller) may be communicatively coupled to other devices such as the RAN 110.

While FIG. 5 represents the communication devices described above with respect to FIG. 1, depending on the type of the communication device, the communication device 500 may include fewer or additional components in configurations different from that illustrated in FIG. 5. For example, in some embodiments, communication device 500 acting as the infrastructure may not include one or more of the screen 505, input device 506, microphone 520, imaging device 521, and speaker 522. As another example, in some embodiments, the communication device 500 acting as the radio may further include a location determination device (for example, a global positioning system (GPS) receiver). Other combinations are possible as well. In general, communications device 500 includes the features provided by current mobile communications devices, such as smartphones.

As shown in FIG. 5, communication device 500 includes a communications unit 502 coupled to a common data and address bus 517 of a processing unit 503. The communication device 500 may also include one or more input devices (e.g., keypad, pointing device, touch-sensitive surface, etc.) 506 and an electronic display screen 505 (which, in some embodiments, may be a touch screen and thus also act as an input device 506), each coupled to be in communication with the processing unit 503.

The microphone 520 may be present for capturing audio from a user and/or other environmental or background audio that is further processed by processing unit 503 in accordance with the remainder of this disclosure and/or is transmitted as voice or audio stream data, or as acoustical environment indications, by communications unit 502 to other portable radios and/or other communication devices. The imaging device 521 may provide video (still or moving images) of an area in a field of view of the communication device 500 for further processing by the processing unit 503 and/or for further transmission by the communications unit 502. A speaker 522 may be present for reproducing audio that is decoded from voice or audio streams of calls received via the communications unit 502 from other portable radios, from digital audio stored at the communication device 500, from other ad-hoc or direct mode devices, and/or from an infrastructure RAN device, or may playback alert tones or other types of pre-recorded audio.

The processing unit 503 may include a code Read Only Memory (ROM) 512 coupled to the common data and address bus 517 for storing data for initializing system components. The processing unit 503 may further include an electronic processor 513 (for example, a microprocessor or another electronic device) coupled, by the common data and address bus 517, to a Random Access Memory (RAM) 504 and a static memory 516.

The communications unit 502 may include one or more wired and/or wireless input/output (I/O) interfaces 509 that are configurable to communicate with other communication devices, such as the radios 140, 145, and 150, and the wireless RAN 115.

For example, the communications unit 502 may include one or more wireless transceivers 508, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 502 may additionally or alternatively include one or more wireline transceivers 508, such as an Ethernet transceiver, a USB transceiver, or similar transceiver configurable to communicate via a twisted pair wire, a coaxial cable, a fiber-optic link, or a similar physical connection to a wireline network. The transceiver 508 is also coupled to a combined modulator/demodulator 510.

The electronic processor 513 has ports for coupling to the display screen 505, the input device 506, the microphone 520, the imaging device 521, and/or the speaker 522. Static memory 516 may store operating code 525 for the electronic processor 513 that, when executed, performs one or more of the steps set forth in blocks 405-450 and accompanying text. The static code may include code to collect performance points/parameters that may be used in the communications assurance analysis techniques described herein.

The static memory 516 may comprise, for example, a hard-disk drive (HDD), an optical disk drive such as a compact disk (CD) drive or digital versatile disk (DVD) drive, a solid state drive (SSD), a flash memory drive, or a tape drive, and the like.

FIG. 6 is an example of a device 600 that may implement the call stage tree analysis engine according to the techniques described herein. It should be understood that FIG. 6 represents one example implementation of a computing device that utilizes the techniques described herein. Although only a single processor is shown, it would be readily understood that a person of skill in the art would recognize that distributed implementations are also possible. For example, the various pieces of functionality described above (e.g. retrieving performance points, visualizing call stage trees, etc.) could be implemented on multiple devices that are communicatively coupled. FIG. 6 is not intended to imply that all the functionality described above must be implemented on a single device.

Device 600 may include processor 610, memory 620, non-transitory processor readable medium 630, and performance points database 640.

Processor 610 may be coupled to memory 620. Memory 620 may store a set of instructions that when executed by processor 610 cause processor 610 to implement the techniques described herein. Processor 610 may cause memory 620 to load a set of processor executable instructions from non-transitory processor readable medium 630. Non-transitory processor readable medium 630 may contain a set of instructions thereon that when executed by processor 610 cause the processor to implement the various techniques described herein.

For example, medium 630 may include performance points analysis instructions 631. The performance points analysis instructions 631 may cause the processor to retrieve performance points from the performance points database 640 and analyze the performance points to create a call stage tree. The performance points analysis instructions 631 are described throughout this description generally, including places such as the description of blocks 405-430, 480, and 485.

The medium 630 may include timeline creation instructions 632. The timeline creation instructions 632 may cause the processor to create a timeline of all calls within a specified time period. An individual call may be selected to drill down to the call stage tree for that specific call. The timeline creation instructions 632 are described throughout this description generally, including places such as the description of blocks 465 and 470.

The medium 630 may include visualization instructions 633. The visualization instructions 633 may cause the processor to provide visualizations, such as call stage trees and timelines that allow the user to interact with the visualization to perform communications assurance analysis. For example, the user may interact with the visualization to drill down into an individual radio call and explore specific parameters for each stage of the call tree for that call. The visualization instructions 633 are described throughout this description generally, including places such as the description of blocks 435, 440, and 450.

The medium 630 may include audio output instructions 634. The audio output instructions 634 may cause the processor to retrieve audio, either as transmitted by a call initiator or received by one or more call recipients, audio of the call that was transmitted or received. This audio may then be played out to determine what exactly was heard. The audio output instructions 634 are described throughout this description generally, including places such as the description of blocks 445 and 455.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot provide a visualization of a call stage tree alongside a call timeline, among other features and functions set forth herein). Furthermore, the techniques described herein are integrated into the practical application of diagnosing faults in a radio communications system.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
retrieving, by a communications assurance analysis system, performance points of a plurality of stages of a single radio call;
determining a level of degradation for each stage of the plurality of stages of the single radio call based on the performance points;
displaying a visualization of each stage of the single radio call, the visualization in order of a communication path between an initiator of the single radio call and at least one recipient of the single radio call, wherein the visualization for each stage of the plurality of stages is based on the level of degradation for the stage.

2. The method of claim 1 wherein determining the level of degradation for each stage of the plurality of stages based on the performance points further comprises:
retrieving a set of parameters associated with each stage, the set parameters indicative of types of failures within the stage;
weighting each parameter of the set of parameters based on the performance points to create a set of weighted parameters; and
combining the set of weighted parameters, wherein the level of degradation of the stage is based on the combination of the set of weighted parameters.

3. The method of claim 1 further comprising:
displaying, on the visualization, a control to play the single radio call as transmitted; and
when the control to play the single radio call is activated:
retrieve a recording of the single radio call as sent by the initiator of the single radio call; and
output the recording of the radio call as sent by the initiator of the single radio call.

4. The method of claim 1 further comprising:
displaying, on the visualization, a control to play the single radio call as received by the at least one recipient of the single radio call; and
when the control to play the single radio call is activated:
retrieve a recording of the single radio call as received by the at least one recipient of the single radio call; and
output the recording of the radio call as received by the at least one recipient of the single radio call.

5. The method of claim 1 further comprising:
displaying a timeline of a plurality of single radio calls, the timeline allowing a user to select an individual radio call from the plurality of single radio calls; and
providing the visualization for the selected individual radio call.

6. The method of claim 1 where the plurality of stages of a single radio call comprises at least one of a radio frequency transmission, an inbound radio frequency reception, and an outbound radio frequency transmission.

7. The method of claim 1 further comprising:
retrieving the level of degradation for each stage of the plurality of stages of the single radio call for a plurality of single radio calls; and
computing an overall score based on the level of degradation for each stage for the plurality of single radio calls, wherein the overall score indicates a health of a communications system being analyzed by the communications assurance analysis system.

8. A system comprising:
a processor; and
a memory coupled to the processor, the memory containing a set of instructions thereon that when executed by the processor cause the processor to:
retrieve, by a communications assurance analysis system, performance points of a plurality of stages of a single radio call;
determine a level of degradation for each stage of the plurality of stages of the single radio call based on the performance points;
display a visualization of each stage of the single radio call, the visualization in order of a communication path between an initiator of the single radio call and at least one recipient of the single radio call, wherein the visualization for each stage of the plurality of stages is based on the level of degradation for the stage.

9. The system of claim 8 wherein the instructions to determine the level of degradation for each stage of the plurality of stages based on the performance points further comprises instructions to:
retrieve a set of parameters associated with each stage, the set parameters indicative of types of failures within the stage;
weight each parameter of the set of parameters based on the performance points to create a set of weighted parameters; and
combine the set of weighted parameters, wherein the level of degradation of the stage is based on the combination of the set of weighted parameters.

10. The system of claim 8 further comprising instructions to:
display, on the visualization, a control to play the single radio call as transmitted; and
when the control to play the single radio call is activated:
retrieve a recording of the single radio call as sent by the initiator of the single radio call; and
output the recording of the radio call as sent by the initiator of the single radio call.

11. The system of claim 8 further comprising instructions to:
display, on the visualization, a control to play the single radio call as received by the at least one recipient of the single radio call; and
when the control to play the single radio call is activated:
retrieve a recording of the single radio call as received by the at least one recipient of the single radio call; and
output the recording of the radio call as received by the at least one recipient of the single radio call.

12. The system of claim 8 further comprising instructions to:
display a timeline of a plurality of single radio calls, the timeline allowing a user to select an individual radio call from the plurality of single radio calls; and
provide the visualization for the selected individual radio call.

13. The system of claim 8 wherein the plurality of stages of a single radio call comprises at least one of a radio frequency transmission, an inbound radio frequency reception, and an outbound radio frequency transmission.

14. The system of claim 8 further comprising instructions to:
retrieve the level of degradation for each stage of the plurality of stages of the single radio call for a plurality of single radio calls; and
compute an overall score based on the level of degradation for each stage for the plurality of single radio calls, wherein the overall score indicates a health of a communications system being analyzed by the communications assurance analysis system.

15. A non-transitory processor readable medium containing a set of instructions thereon that when executed by a processor cause the processor to:
retrieve, by a communications assurance analysis system, performance points of a plurality of stages of a single radio call;
determine a level of degradation for each stage of the plurality of stages of the single radio call based on the performance points;
display a visualization of each stage of the single radio call, the visualization in order of a communication path between an initiator of the single radio call and at least one recipient of the single radio call, wherein the visualization for each stage of the plurality of stages is based on the level of degradation for the stage.

16. The medium of claim 15 wherein the instructions to determine the level of degradation for each stage of the plurality of stages based on the performance points further comprises instructions to:
retrieve a set of parameters associated with each stage, the set parameters indicative of types of failures within the stage;
weight each parameter of the set of parameters based on the performance points to create a set of weighted parameters; and
combine the set of weighted parameters, wherein the level of degradation of the stage is based on the combination of the set of weighted parameters.

17. The medium of claim 15 further comprising instructions to:
display, on the visualization, a control to play the single radio call as transmitted; and
when the control to play the single radio call is activated:
retrieve a recording of the single radio call as sent by the initiator of the single radio call; and
output the recording of the radio call as sent by the initiator of the single radio call.

18. The medium of claim 15 further comprising instructions to:
display, on the visualization, a control to play the single radio call as received by the at least one recipient of the single radio call; and
when the control to play the single radio call is activated:
retrieve a recording of the single radio call as received by the at least one recipient of the single radio call; and
output the recording of the radio call as received by the at least one recipient of the single radio call.

19. The medium of claim 15 further comprising instructions to:
display a timeline of a plurality of single radio calls, the timeline allowing a user to select an individual radio call from the plurality of single radio calls; and
provide the visualization for the selected individual radio call.

20. The medium of claim 15 further comprising instructions to:
retrieve the level of degradation for each stage of the plurality of stages of the single radio call for a plurality of single radio calls; and
compute an overall score based on the level of degradation for each stage for the plurality of single radio calls, wherein the overall score indicates a health of a communications system being analyzed by the communications assurance analysis system.
